(19) United States
(12) Patent Application Publication
(10) Pub. No.: US 2014/0255287 A1
(43) Pub. Date: Sep. 11, 2014

(54) PRODUCTION OF PHOSPHORIC ACID BY A TWO-STAGE CRYSTALLIZATION PROCESS

(71) Applicant: MOS Holdings Inc., Plymouth, MN (US)

(72) Inventors: Paul Kucera, Valrico, FL (US); Colin G. Weyrauch, Brandon, FL (US)

(73) Assignee: MOS Holdings Inc., Plymouth, MN (US)

(21) Appl. No.: 14/202,129

(22) Filed: Mar. 10, 2014

Related U.S. Application Data
(60) Provisional application No. 61/775,049, filed on Mar. 8, 2013.

(51) Int. Cl. C01B 25/229

(52) U.S. Cl. CPC C01B 25/2295
USPC 423/320; 422/187

(57) ABSTRACT

A process and system for producing phosphoric acid. Phosphate rock is dissolved in phosphoric acid in a reaction vessel to form a slurry. The slurry is then reacted in a first stage of crystallization with sulfuric acid to produce calcium sulfate hemihydrate and phosphoric acid. The product acid is separated from the hemihydrates via filtration, and the filter cake is then reacted, in a second crystallization step, with additional sulfuric acid to produce dihydrate calcium sulfate (gypsum) and recovery solution. The gypsum is separated from the recovery solution via filtration and removed as a by-product. The recovery solution is recycled back to the transformation tank and to the hemihydrate filtration step. A feed acid tank combines wash solution, recovery solution and product acid. Once adjusted to a target P₂O₅ concentration, it is fed to the initial reactor vessel to dissolve the phosphate ore.

### RELATED APPLICATION

The present application claims the benefit of U.S. Provisional Application No. 61/775,049 filed Mar. 8, 2013, which is incorporated herein in its entirety by reference.

### FIELD OF THE INVENTION

The present invention is generally directed to the production of phosphoric acid, and more particularly to a two-stage crystallization and filtration process employing a feed acid tank assembly and recovery solution tank assembly for the production of high strength phosphoric acid with a high recovery of P₂O₅.

### BACKGROUND OF THE INVENTION

Phosphoric acid (H₃PO₄) has a number of commercial uses from its use in the production of agricultural products, such as fertilizers and animal feeds, to its incorporation into food products. Phosphoric acid concentration can be expressed in several ways including percent phosphoric acid (% H₃PO₄), percent phosphorous pentoxide (% P₂O₅) or percent phosphorous (% P) using the following conversion factors to convert between concentration units:

% H₃PO₄×0.724=% P₂O₅%

% H₃PO₄×0.316=% P

% P₂O₅×0.436=% P

For the purposes of this application going forward and for sake of consistency and simplicity, phosphoric acid concentration will be expressed as P₂O₅ concentration (% P₂O₅). The concentration or strength of phosphoric acid defines its suitability for a particular use. For example, commercial grade phosphoric acid has a P₂O₅ concentration or purity of about 50-54% whereas food grade P₂O₅ has a concentration or purity of about 54-62%.

Phosphoric acid for use in agricultural products, such as fertilizers and animal feeds, is commonly produced by a wet process. In a wet process, mined phosphate rock or phosphate ore, such as tricalcium phosphate rock or apatite, is dissolved or acidulated by the addition of sulfuric acid to yield phosphoric acid and insoluble calcium sulfate by-product. The overall chemical reaction in simplified form is:

Ca₃(PO4)₂+3H₂SO₄+6H₂O=3CaSO₄.2H₂O+H₃PO₄ (1A)

The overall reaction can be broken down into two separate steps. First, the formation of monocalcium phosphate by reaction of the phosphate rock with excess phosphoric acid, either added to the process and/or recycled, in the following reaction:

Ca₃(PO4)₂+4H₃PO₄=3Ca(H₂PO₄)₂ (2A)

Second, the reaction of the monocalcium phosphate with sulfuric acid to form additional phosphoric acid and calcium sulfate in the following reaction:

3Ca(H₂PO₄)₂+3H₂SO₄=3CaSO₄+6H₃PO₄ (3A)

The calcium sulfate by-product can be obtained in various crystalline forms depending on the concentrations of various reactants in each of the above reactions and the temperature of the reactions. Two particular forms of calcium sulfate include calcium sulfate dihydrate (CaSO4.2H20), otherwise known as gypsum, and calcium sulfate hemihydrate (CaSO4.½H20). The former, or the dihydrate form, is a stable crystalline form which is readily filterable and washable in process. However, because of its stable crystalline form, phosphate can become trapped within its structure, resulting in a net phosphate loss to the system, decreasing the system overall efficiencies, which in turn, translates to increased production costs. Furthermore, the then phosphate-contaminated gypsum may be unsuitable for its end use, such as for cements, plasters, or the like.

The hemihydrate form, on the other hand, has a much less stable crystalline structure, and, if filtering conditions are not closely monitored and controlled, has the propensity to hydrate on the filter. Hydration on the filter can result in an unfilterable mass which leads to process shutdowns, and ultimately increased production costs.

Therefore, each step of the wet process and its various parameters, including reactant concentrations and reaction temperatures, must be carefully monitored, measured and controlled to reduce the process variability by maximizing filterability of the calcium sulfate by-product(s) and/or phosphate or P2O5 recovery. A variety of wet processes have been developed for the production of phosphoric acid, mainly with one or more of these goals in mind.

U.S. Pat. No. 4,059,674 to Lopker, for example, is directed to a process for producing phosphoric acid and gypsum, employing three stages of crystallization to increase phosphate recovery. Per the Abstract section, “calcium phosphate rock particles [are mixed with] recycled phosphoric and sulfuric acids . . . to form additional phosphoric acid and calcium sulfate dihydrate (gypsum) . . . . A gypsum slurry is withdrawn and product phosphoric acid is separated therefrom and withdrawn from the process . . . . The gypsum is passed to a first recrystallizer wherein sulfuric acid is introduced, and the gypsum is recrystallized to hemihydrate. A slurry of the hemihydrate is passed to a second recrystallizer, wherein water obtained as described below is added and the hemihydrate is recrystallized to gypsum . . . .”

U.S. Pat. No. 4,777,027 to Davister et al. is directed to a continuous process for preparing phosphoric acid and calcium sulfate. As described at column 1, lines 5-19, the method comprises “subjecting in a mixture containing calcium sulphate flowing through a reaction zone sequence, calcium phosphate to an attack by a mixture of sulfuric and phosphoric acids, while separating calcium sulphate and extracting at least part of the production phosphoric acid . . . . [The] calcium sulphate . . . by-product . . . may notably be comprised of dihydrate, α-hemihydrate, II-anhydrite or a mixture in very varying ratios of two or three said crystalline forms . . . .” As shown in FIG. 2, various recycle and feed lines directly feed the first reactor in the series of reactors.

U.S. Pat. No. 4,853,201 to Ore et al. discloses a “process for recovering P2O5 values from hemihydrate crystals generated during the hemihydrate process for manufacturing phosphoric acid compris[ing] converting the hemihydrate crystals to dihydrate crystals by recrystallization in a crystallizer having a phosphoric acid concentration in the range of about 0.1% to about 10% on a P2O5 basis, and a free sulfate concentration in the range of about 0.1% to 10% . . . . The crystallizer operates at low P2O5 and high sulfate levels, thereby reducing the hydration time, which is a major benefit of this process . . . .”

Similarly, U.S. Pat. No. 3,632,307 to Cornelis van Es et al. discloses a process in which “[p]hosphoric acid and gypsum are prepared from phosphate rock by acidulating same with sulfuric acid or a mixture of sulfuric and phosphoric acids to form a slurry of CaSO₄.½H₂O [calcium sulfate hemihydrate] in phosphoric acid. The CaSO₄.½H₂O is washed to removed adhered phosphoric acid and recrystallized from a solution containing phosphoric and sulfuric acids to form CaSO₄.2H₂O [gypsum].”

These processes all use some form of recycle within the process, such as, for example, recycle of the recovery solution(s) from the filtrations step(s), and/or recycle of the wash solutions from the filtration step(s). These recycle lines are fed directly into the initial reaction vessel or acidulation tank and/or into the filtrations steps. Because each of these lines must be closely and accurately measured and monitored, process controllability issues can quickly arise due to the volume of lines feeding the different unit operations. For example, if there is variability in the measurement system such that the measures of one or more of the recycle lines is inaccurate, this can cause the concentration of reactants in the crystallizer to be off target (e.g. low sulfate levels), which causes the crystallizer to operate incorrectly, resulting in small crystal size, for example. In turn, this results in poor filtration or filtration variability, leading to loss of P₂O₅, and ultimately an increase in production costs. Similarly, unwanted co-crystallization can occur with similar effects downstream, as well as poor digestion in the acidulation tank if the incoming feeds are poorly controlled, i.e. the variability is too high.

There remains a need for a process of producing phosphoric acid with high yield of P205 and high strength product acid by reducing the potential for measurement error and therefore reducing the system and process variability.

### SUMMARY OF THE INVENTION

Embodiments of the invention are directed to a two-stage crystallization and filtration process for producing phosphoric acid. In an embodiment, the process comprises a first reactor including a rock slurry tank and a dissolver in which mined wet rock is dissolved with phosphoric acid and optionally sulfuric acid to produce a rock slurry. The slurry is then fed to a first crystallizer/filtration assembly including a crystallizer and a hemihydrate filtration system. In the crystallizer, the rock slurry is reacted with sulfuric acid to produce product phosphoric acid and calcium sulfate hemihydrate. The product acid is extracted from the calcium sulfate hemihydrate in the first filtration assembly, and the product acid is fed to a product acid tank. The filter cake is then washed, and the wash solution is recycled back to a feed acid tank.

The process further comprises a second crystallizer/filtration assembly including a transformation tank and a dihydrate filtration system. The filter cake from the hemihydrate filtration system is fed to the transformation tank where it is reacted with sulfuric acid and a combination of recycled dihydrate recovery solution and wash solution to precipitate calcium sulfate dihydrate or gypsum in the form of a slurry. The slurry is then fed to a dihydrate filtration system in which it is filtered and the recovery solution from this primary filtration is recycled back to the transformation tank. The filtered gypsum is then washed with water, and the gypsum is extracted from the process. The wash solution is then also recycled to the transformation tank.

The process further comprises a feed acid tank assembly for combining recovery solution from the dihydrate primary filtration, wash solution from the hemihydrate wash filtration, and product acid from the product acid tank. The feed acid tank assembly includes a control system for monitoring or measuring and adjusting the P₂O₅ concentration in the feed acid tank, as well as the temperature, flow rate, and other process parameters as needed. Feed acid at a target P₂O₅ concentration from the feed acid tank assembly is then fed directly to the rock slurry tank. The feed acid tank assembly provides a single source of monitoring and regulating the feed acid to the system, rather than monitoring individual feed acid streams as required in the systems of the prior art.

The process also comprises a recovery solution tank assembly to capture the recovery solution from the primary filtration of the calcium sulfate dihydrate before it is reintroduced into the process. Similar to the fee acid tank assembly, the recovery solution tank assembly provides a single point of adjustment and control of the concentration, temperature, and/or flow rate of this recovery solution before it is recycled to one or more of the transformation tank as a reactant, to the hemihydrate wash filtration step as a wash solution for the hemihydrates filter cake, and as an input to feed acid tank assembly.

The feed acid tank assembly and the recovery solution tank assembly each provide a single source of monitoring and regulating the feed acid and the recycled recovery solution, respectively, to the system which results in better control of the process, less concentration variability in the various streams throughout the process, and less filter variability such that the process is efficient, economical, and stable, while producing high strength acid having concentrations of 39% P₂O₅ or higher and high P₂O₅ yields from the phosphate ore of 99% or greater.

The above summary of the invention is not intended to describe each illustrated embodiment or every implementation of the present invention. The figures and the detailed description that follow more particularly exemplify these embodiments.

### BRIEF DESCRIPTION OF THE DRAWINGS

The invention can be completely understood in consideration of the following detailed description of various embodiments of the invention in connection with the accompanying drawing(s), in which:

FIG. 1 is a process flow diagram of a process for producing phosphoric acid according to an embodiment of the invention.

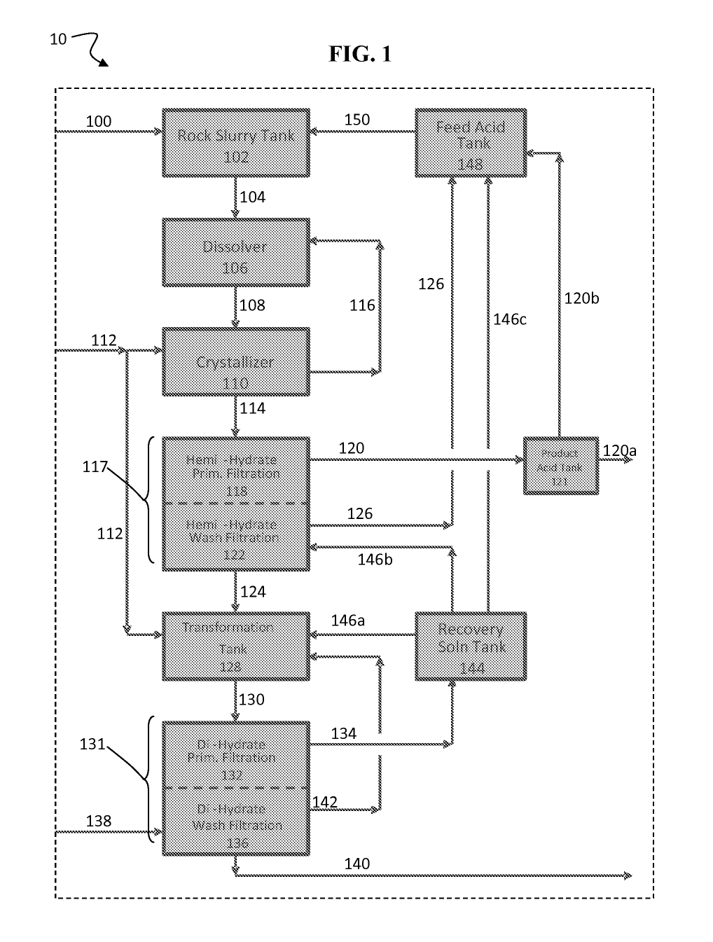

While the invention is amenable to various modifications and alternative forms, specifics thereof have been shown by way of example in the drawings and is described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

In embodiments of the invention, a hemihydrate/dihydrate process 10 (hereinafter “the HH-DH process 10”) for the production of phosphoric acid comprises two stages of crystallization and filtration to achieve high recovery of P₂O₅ and high strength (or high concentration) product acid. In addition, process 10 includes a feed acid tank assembly 148 comprising one or more tanks to which product acid and other recycle streams are combined, measured, and optionally adjusted before being introduced as a single feed acid stream into the initial reactor or rock slurry tank, allowing for better process controllability and process efficiencies, while reducing process variability and sampling error. Process 10 also includes a recovery solution tank assembly 144 comprising one or more tanks to which recovery solution from the dihydrate filtration step 132 is fed, measured, and optionally adjusted before being introduced as one or more recycle streams back into process 10 at various points.

First, in a rock slurry tank 102, wet rock 100 and adjusted feed acid stream 150 are combined. Wet rock 100 can be pulverized or otherwise processed before entering rock slurry tank 102 to increase the surface area of the phosphate rock for better, more complete digestion. Adjusted feed acid stream 150 contains a combination of recycle and product acid streams at a target P₂O₅ concentration from feed acid tank assembly 148, as is described in more detail below. In the rock slurry tank 102, the CO₂ in the rock is liberated as shown in reaction (1):

CaCO₃+2H₃PO₄→Ca²⁺+2H₂PO₄⁻+CO₂+H₂O (1)

The removal of the CO₂ gas in the rock slurry tank allows for consistent dissolver operation.

Rock slurry 104 from rock slurry tank 102 and re-circulated crystallizer slurry 116 (described below) are fed to a dissolver 106. In the dissolver 106, rock is dissolved by phosphoric acid into mono-calcium phosphate slurry 108 (or dissolver slurry 108) as shown in reaction (2):

Ca₁₀(PO₄)₆F₂+12H₃PO₄→9Ca²⁺+18H₂PO₄⁻+CaF₂ (2)

In the dissolver 106, the P₂O₅ concentration is maintained above 39% and the Ca²⁺ concentration is maintained around 1% in order to maximize rock dissolution. Undissolved rock losses are expected to be or comprise less than 0.5% of the rock P₂O₅ fed.

Fresh sulfuric acid (H₂SO₄) 112 and dissolver slurry 108 are fed to a crystallizer 110. In the crystallizer 110, Ca²⁺ precipitates with SO₄²⁻ as hemihydrate gypsum as shown in reaction (3):

Ca²⁺+SO₄²⁻+½H₂O→CaSO₄.½H₂O (3)

The SO₄²⁻ concentration in the crystallizer 110 is maintained at about 2% for good crystal growth and good filterability in subsequent filtration. Due to the high P₂O₅ concentration in the crystallizer 110, co-crystallization of di-calcium phosphate also occurs as shown in reaction (4):

Ca²⁺+HPO₄²⁻→CaHPO₄ (4)

This reaction would otherwise account for 6% to 8% P₂O₅ loss if the crystallizer solids were discharged without further processing.

Crystallizer slurry 114, made up of a combination of hemihydrate gypsum and di-calcium phosphate, is fed to a hemihydrate filter system 117 to separate product acid (H₃PO₄) 120 from the solids. Product acid 120 is sent to product acid tank 121 where it is used for commercial sale of product acid 120a and/or it is sent via 120b to feed acid tank assembly 148 before reentry or being recycled into process 10 as needed.

After primary filtration at 118, phosphoric acid remains in the filter cake. Recovery solution 146b (described in further detail below), including phosphoric acid and excess sulfuric acid, is used to wash the phosphoric acid from the cake at hemihydrate wash filtration step 122, and the resulting wash solution 126 is returned to the feed acid tank assembly 148. Soluble P₂O₅ losses after washing would account for 2% to 4% P₂O₅ loss if the cake were discharged after filtration without further processing.

Washed hemihydrate filter cake 124, fresh sulfuric acid 112, dihydrate filter wash solution 142, and adjusted recovery solution 146a are then mixed in transformation tank 128. In the transformation tank 128, hemihydrate gypsum and co-crystallized P₂O₅ loss dissolve as shown in reactions (5) & (6):

CaSO₄.½H₂O→Ca²⁺SO₄²⁻+½H₂O (5)

CaHPO₄+H₂SO₄→Ca²⁺SO₄²⁻+H₃PO₄ (6)

Also, dihydrate gypsum crystallizes as shown in reaction (7):

Ca²⁺+SO₄²⁻+2H₂O→CaSO₄.2H₂O (7)

The SO₄²⁻ concentration in the transformation tank is maintained above about 1%, and more particularly above about 3%, and more particularly above about 5% to prevent or inhibit crystallization of di-calcium phosphate. At this concentration, co-crystallized losses are expected to be less than 0.5% of the rock P₂O₅ fed.

Transformation tank slurry 130, which includes dihydrate gypsum, is fed to a dihydrate filter system 131 to separate recovery solution 134 from the solids. Recovery solution 134 is then sent to recovery solution tank assembly 144, comprising one or more tanks. Recovery solution tank assembly 144 allows for a single point of adjustment and control of the concentration, temperature, and/or flow of recovery solution 134 before it is recycled to one or more of transformation tank 128 at 126a, hemihydrate wash filtration step 122 at 126b, and/or feed acid tank assembly 148 at 126c.

After primary filtration 132, recovery solution remains in the filter cake. Water 138, such as, for example, fresh water from the battery limits, process water, and/or other applicable water sources, is used to wash this recovery solution from the cake in a wash filtration step 136, and the resulting wash solution 142 is returned to the transformation tank 128. Soluble P₂O₅ losses after washing are expected to be less than 0.5% of the rock P₂O₅ fed. Dihydrate gypsum 140 is extracted from the wash filtration step 136.

As mentioned above, the feed acid tank assembly 148, comprising one or more tanks supplies adjusted feed acid stream 150 to rock slurry tank 102 at the beginning of process 10 as a single feed acid stream 150. Adjusted feed acid stream 150 is made up of the combined streams in feed acid tank assembly 148 including hemihydrate wash solution 126 from hemihydrate wash filtration step 122, adjusted recovery solution 146c from recovery solution tank assembly 144, and product acid 120b from product acid tank 121 as needed. By incorporating feed acid tank assembly 148, the acid feed stock, or feed acid stream 150, is simplified to a single source, allowing for better control and more consistent concentration of feed acid stream 150. In other words, the feed acid tank assembly 148 acts as a buffer for the feed acid stream 150, allowing adjustments to acid or reactant concentrations, flow, and/or temperatures at tank assembly 148 before entry into rock slurry tank 102.

Furthermore, the use of feed acid tank assembly 148 to produce a single adjusted feed acid stream 150, as opposed to multiple streams directly feeding into rock slurry tank 102, requires a single measurement system for monitoring the concentration and flow of feed acid stream 150. This eliminates the need for complex measurement and control systems needed in the processes of the prior art. In the prior art, a separate instrument or measurement system is required to measure or monitor each individual feed into the initial reactor or acidulating tank, which increases the likelihood of equipment or measurement/sampling error. By using feed acid tank assembly 148, only a single feed acid stream (or P₂O₅ concentration) requires monitoring and controlling, thereby reducing the likelihood of measurement error and reducing control variability, which in turn reduces variability in the concentrations of the unit operations, such as the dissolver 106, the crystallizer 110, and/or the transformation tank 128, throughout process 10. This results in better control and less variability in the filterability of both the hemihydrate and dihydrate gypsum, creating a more economic, better controlled process, and overall higher P₂O₅ yield.

Similarly, recovery solution tank assembly 144 also acts as a buffer to monitor the input stream 146a into transformation tank 128 as well as input stream 146b to hemihydrate wash filtration step 122 and input stream 146c to feed acid tank assembly 148. Controlling one or more of concentration, flow, and temperature of recovery solution 134 at a single point before re-entry into process 10 allows for reduction of sources of sampling and measurement error in the system, resulting in the reduction of process variability and increase in process efficiency.

According to a non-limiting embodiment of the invention, a control system includes control of flows to each of the unit operations described above. However, alternative control systems can also be contemplated, and the control system described below is for exemplary purposes only.

### Rock Slurry Tank 102

Flow of rock slurry 104 to the dissolver 106 is controlled by operator to adjust to the target plant rate. Flow of wet rock 100 to the rock slurry tank 102 is ratio controlled to the flow of rock slurry 104 to the dissolver 106. Rock slurry tank level controls the wet rock 100 to rock slurry 104 ratio.

Flow of feed acid stream 150 to the rock slurry tank 102 is ratio controlled to the flow of wet rock 100 to the rock slurry tank 102. The rock slurry tank solids is controlled by operator adjustment of the feed acid stream 150 to wet rock 100 ratio. The crystallizer solids is controlled by adjusting the rock slurry tank solids target.

Feed Acid Tank assembly 148

Flow of product acid via 120b to feed acid tank assembly 148 is cascade controlled by the feed acid tank level. The flow of recovery solution 146c is ratio controlled to the flow of product acid 120b to tank assembly 148. Feed acid tank P₂O₅ concentration is then controlled by operator adjustment of the recovery solution to product acid ratio. Crystallizer P₂O₅ concentration is then controlled by simply adjusting the feed acid P₂O₅ concentration target—a single source as opposed to multiple sources of P₂O₅.

### Dissolver 106

Flow of crystallizer slurry 116 to the dissolver 106 is ratio controlled to the flow of rock slurry 104 to the dissolver 106. Dissolver Ca²⁺ concentration is controlled by operator adjustment of the crystallizer slurry 116 to rock slurry 104 ratio.

Flow of dissolver slurry 108 to the crystallizer 110 is cascade controlled by the level in the dissolver 106.

### Crystallizer 110

Flow of sulfuric acid 112 to the crystallizer 110 is ratio controlled to the flow of rock slurry 104 to the dissolver 106. Crystallizer SO₄²⁻ concentration is controlled by operator adjustment of the sulfuric acid 112 to rock slurry 104 ratio.

Pressure in the crystallizer is cascade controlled by the crystallizer temperature. Crystallizer temperature is set by the operator.

### Hemihydrate Filter 117

Flow of crystallizer slurry 114 to the hemihydrate primary or HH primary filter 118 is cascade controlled by the level in the crystallizer 110.

Flow of adjusted recovery solution 146b to the HH wash filter 122 is ratio controlled to the flow of crystallizer slurry 114 to the HH filter 119. HH wash solution P₂O₅ concentration is controlled by operator adjustment of the recovery solution 146b to crystallizer slurry 114 ratio. Flow of HH wash solution 126 is directed to the feed acid tank assembly 148.

Speed of the HH filter is ratio controlled to the flow of crystallizer slurry 114 to the HH primary filter 118. HH filter cake thickness is controlled by operator adjustment of the filter speed to crystallizer slurry ratio. The flow of recovery solution 126 to the feed acid tank assembly 148 is controlled by adjusting the HH filter cake thickness target.

### Transformation Tank 128

Flow of adjusted recovery solution 146a to the transformation tank 128 is adjusted by the operator to control transformation tank solids.

Flow of sulfuric acid 112 to the transformation tank 128 is ratio controlled to the total of the flow of adjusted recovery solution 146a and DH wash solution 142 to the transformation tank 128. Transformation tank SO₄²⁻ concentration is controlled by operator adjustment of the sulfuric acid 112 to recovery 146a and DH wash 142 ratio.

### Dihydrate Filter 131

Flow of transformation slurry 130 to the dehydrate or DH primary filter 132 is cascade controlled by the level in the transformation tank 128.

Flow of water 138 to the DH filter 136 is ratio controlled to the flow of transformation slurry 130 to the DH filter 132. Recovery solution tank assembly 144 level will control the water 138 to transformation slurry 130 ratio.

Flow of DH wash solution 142 is directed to the transformation tank 128.

Speed of the DH filter is ratio controlled to the flow of transformation slurry 130 to the DH filter 132. DH filter cake thickness is controlled by operator adjustment of the filter speed to transformation slurry ratio. The flow of adjusted recovery solution 146a to the transformation tank 128 is controlled by adjusting the DH filter cake thickness target.

### Product Acid Tank 121

Flow of product acid 120a to the battery limits is cascade controlled by the product acid tank level.

By reducing the filter variability and the feed acid concentration variability, the HH-DH process 10 produces phosphoric acid having a concentration in a range of about 35% to about 45% P₂O₅, and more particularly of about 39% P₂O₅ or more at >99% P₂O₅ recovery.

Various embodiments of systems, devices and methods have been described herein. These embodiments are given only by way of example and are not intended to limit the scope of the invention. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the invention.

Persons of ordinary skill in the relevant arts will recognize that the invention may comprise fewer features than illustrated in any individual embodiment described above. The embodiments described herein are not meant to be an exhaustive presentation of the ways in which the various features of the invention may be formed or combined. Accordingly, the embodiments are not mutually exclusive combinations of features; rather, the invention may comprise a combination of different individual features selected from different individual embodiments, as understood by persons of ordinary skill in the art.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

1. A method for producing phosphoric acid, comprising:
adjusting one or more feed acid variables of a feed acid within a feed acid tank to form an adjusted feed acid, said feed acid tank having a plurality of incoming acid streams;
supplying the adjusted feed acid from the feed acid tank to a slurry tank wherein phosphate ore is dissolved with the feed acid to form a phosphate slurry;
crystallizing the phosphate slurry to form a crystallizer slurry;
subjecting the crystallizer slurry to a series of filtration and wash steps to form a product acid and dehydrate gypsum; and
collecting the product acid in a product acid tank, wherein a portion of the product acid is supplied to the feed acid tank as one of the incoming acid streams.

2. The method of claim 1, wherein forming the phosphate slurry, further comprises:
minimizing undissolved phosphate ore losses to less than 0.5% by maintaining a
P₂O₅ concentration above 39% and a Ca²⁺ concentration of about 1% in a dissolver tank.

3. The method of claim 1, wherein the step of crystallizing the phosphate slurry to form a crystallizer slurry, further comprises:
adding sulfuric acid to the phosphate slurry in a crystallizer tank, wherein an SO₄²⁻ concentration is maintained at about 2% in the crystallizer tank.

4. The method of claim 1, wherein the step of subjecting the crystallizer slurry to a series of filtration and wash step, further comprises:
supplying the crystallizer slurry to a hemihydrate filter system to form the product acid, a first wash solution and a hemihydrate filter cake; and
supplying the hemihydrate filter cake to a dehydrate filter system to form the dehydrate gypsum, a second wash solution and a recovery solution.

5. The method of claim 4, further comprising:
supplying the first wash solution to the feed acid tank as one of the incoming acid streams.

6. The method of claim 4, further comprising:
supplying the recovery solution to a recovery solution tank; and
adjusting one or more recovery solution variables of the recovery solution within the recovery solution tank to form an adjusted recovery solution.

7. The method of claim 6, further comprising:
supplying adjusted recovery solution from the recovery solution tank to the feed acid tank as one of the plurality of incoming acid streams.

8. The method of claim 6, further comprising:
supplying adjusted recovery solution from the recovery solution tank to the hemihydrate filter system.

9. The method of claim 6, wherein supplying the crystallizer slurry to a hemihydrate filter system, further comprises:
filtering the crystallizer slurry to separate the product acid from the hemihydrate filter cake;
washing the filter cake with the adjusted recovery solution to remove residual product acid from the hemihydrate filter cake to form the first wash solution; and
supplying the first wash solution to the feed acid tank as one of the plurality of incoming acid streams.

10. The method of claim 9, further comprising:
mixing the hemihydrate filter cake with sulfuric acid, the adjusted recovery solution and the second wash solution in a transformation tank, wherein an SO₄²⁻ concentration is maintained above about 1% to inhibit crystallization of di-calcium phosphate.

11. The method of claim 10, wherein the one or more feed acid variables are selected from the group consisting essentially of: a feed acid tank level and a feed acid tank P₂O₅ concentration.

12. The method of claim 11, wherein the one or more recovery solution variables are selected from the group consisting essentially of: a recovery tank level, a recovery tank temperature and a flow rate of the recovery solution.

14. A system for producing phosphoric acid, comprising:
a feed acid tank containing an adjusted feed acid, the feed acid tank having a plurality of input streams wherein the feed acid tank is adapted to adjust one or more feed acid variables to form the adjusted feed acid;
a slurry tank for dissolving a phosphate ore with the adjusted feed acid to form a phosphate slurry;
a crystallizer for crystallizing the phosphate slurry to form a crystallizer slurry;
a hemihydrate filter system for separating a product acid, a first wash solution and a hemihydrate filter cake from the crystallizer slurry, wherein the first wash solution is supplied to the feed acid tank as one of the plurality of input streams;
a transformation tank for mixing the hemihydrate filter cake to form a transformation tank slurry;
a dihydrate filter system for separating the transformation tank slurry to form dehydrate gypsum, a second wash solution and a recovery solution; and
a recovery tank containing an adjusted recovery solution, the recovery tank receiving the recovery solution wherein the recovery tank is adapted to adjust one or more recovery solution variables to form the adjusted recovery solution, and wherein the adjusted recovery solution is supplied to the feed acid tank as one of the plurality of input streams.

15. The system of claim 14, further comprising:
a product acid tank for receiving the product acid, wherein a portion of the product acid is supplied to the feed acid tank as one of the plurality of input streams.

16. The system of claim 14, wherein the adjusted recovery solution is supplied to the hemihydrate filter system.

17. The system of claim 14, wherein the adjusted recovery solution is supplied to the transformation tank.

18. The system of claim 14, wherein the one or more feed acid variables are selected from the group consisting essentially of: a feed acid tank level and a feed acid tank P₂O₅ concentration.

19. The method of claim 14, wherein the one or more recovery solution variables are selected from the group consisting essentially of: a recovery tank level, a recovery tank temperature and a flow rate of the recovery solution.
